(19) United States
(12) Patent Application Publication
(10) Pub. No.: US 2014/0109012 A1
(43) Pub. Date: Apr. 17, 2014

(54) THUMBNAIL AND DOCUMENT MAP BASED NAVIGATION IN A DOCUMENT

(71) Applicant: MICROSOFT CORPORATION, Redmond, WA (US)

(72) Inventors: Bibhu Choudhary, Hyderabad (IN); Atish Patel, Mumbai (IN); Nishanth Ramaprakash, Bangalore (IN); Indra Pal Singh, Hyderabad (IN)

(73) Assignee: Microsoft Corporation, Redmond, WA (US)

(21) Appl. No.: 13/653,076

(22) Filed: Oct. 16, 2012

(51) Int. Cl. G06F 3/048

(52) U.S. Cl. 715/838

(57) ABSTRACT

An overview mode is used to navigate content. While in the overview mode, content is displayed as thumbnails such that a user may more easily locate content. A document map may also be displayed with a display of thumbnails while in the overview mode. The document map displays an outline of the content that includes selectable elements to assist in navigating the content. The number of thumbnails displayed may change while in the overview mode (e.g. receiving a pinch/stretch gesture). The thumbnails displayed may also be adjusted (e.g. up/down/left/right) using gestures (e.g. drag, swipe . . . ). A drill down view displays an expanded view of content on a thumbnail in response to receiving a drill down instruction (e.g. a tap and hold gesture on a thumbnail). A thumbnail may also be selected (e.g. tapped) to return to the original viewing mode and to display the content of the selected thumbnail.

### BACKGROUND

Moving to a location in a large document can be difficult. A user often scrolls a document in order to move to a different location within a document. When the document is large it may take a long time for a user to scroll to the portion of the document they are interested in viewing. Scrolling on a mobile computing device having a smaller display may be even more challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An overview mode is used to navigate content. While in the overview mode, content is displayed as thumbnails such that a user may more easily locate content. A document map may also be displayed with a display of thumbnails while in the overview mode. The document map displays an outline of the content that includes selectable elements to assist in navigating the content. The number of thumbnails displayed may change while in the overview mode (e.g. receiving a pinch/stretch gesture). The thumbnails displayed may also be adjusted (e.g. up/down/left/right) using gestures (e.g. drag, swipe . . . ) to show other thumbnails. A drill down view displays an expanded view of content on a thumbnail in response to receiving a drill down instruction (e.g. a tap and hold gesture on a thumbnail). A thumbnail may also be selected (e.g. tapped) to return to the original viewing mode and to display the content of the selected thumbnail.

### BRIEF DESCRIPTION OF THE DRAWINGS

FIG. 1 shows a system for navigating content using an overview mode;

FIG. 2 shows entering an overview mode and changing a number of thumbnails displayed;

FIG. 3 illustrates changing a display of the thumbnails in the overview mode;

FIG. 4 shows displaying a drill down view for a thumbnail while in overview mode and showing a single page view in response to selecting a thumbnail;

FIG. 5 illustrates changing a display of the thumbnails;

FIG. 6 illustrates changing a display of the thumbnails;

FIG. 7 illustrates entering an overview mode with a display of a document map;

FIG. 8 shows an illustrative processes for entering an overview mode and navigating content using the overview mode;

FIG. 9 shows a diagram illustrating processing different gestures while in an overview mode;

FIG. 10 illustrates an exemplary system for using an overview mode to navigate content; and

FIGS. 11-13 and the associated descriptions provide a discussion of a variety of operating environments in which embodiments of the invention may be practiced.

### DETAILED DESCRIPTION

Referring now to the drawings, in which like numerals represent like elements, various embodiment will be described.

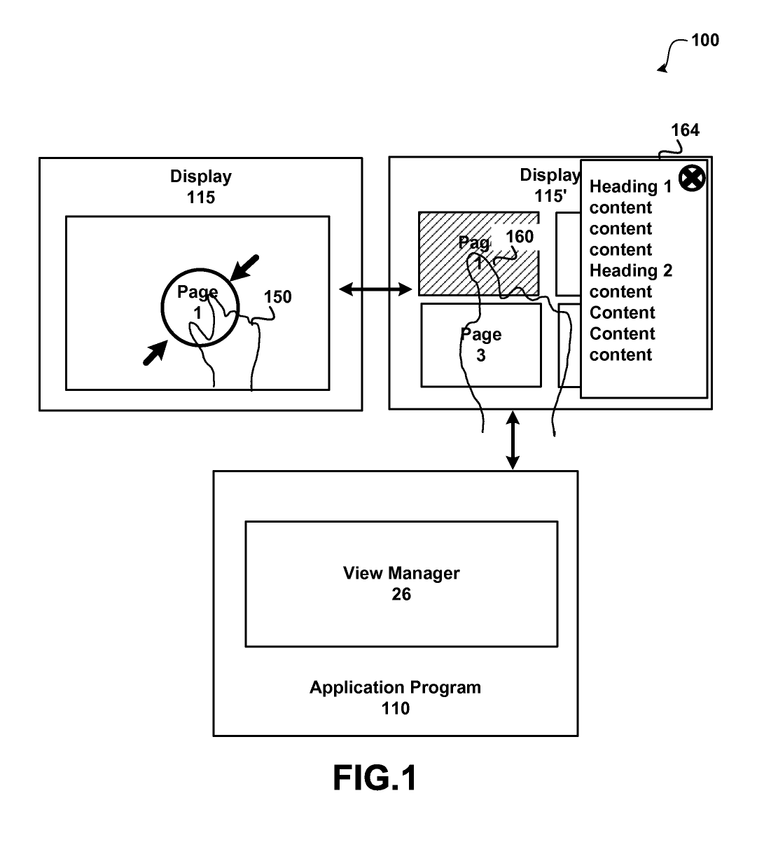

FIG. 1 shows a system for navigating content using an overview mode. As illustrated, system 100 includes application program 110, view manager 26 and touch screen input device/display 115.

In order to facilitate communication with the view manager 26, one or more callback routines, may be implemented. According to one embodiment, application program 110 is a business productivity application that is configured to receive input from a touch-sensitive input device 115 and/or keyboard input (e.g. a physical keyboard and/or SIP) and/or other types of input (e.g. some other input sensing). For example, view manager 26 may provide information to application 110 in response to a user's gesture (i.e. gesture 150) selecting content and other touch based gestures. For example, gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device/display 115 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

View manager 26 is configured to display an overview mode that shows multiple pages of content. In response to receiving an instruction to change the viewing mode to an overview mode (e.g. a pinch gesture as indicated by gesture 150), view manager 26 enters the overview mode. In the current example, a user performs a pinch gesture while in a view mode that is showing page 1 of a document on display 115. In response to determining that the overview mode is to be entered, view manager 26 instructs a display of thumbnails as shown in display 115′. The overview mode can be entered immediately upon receiving a gesture that is associated with entering the overview mode or may be entered using information in addition to receiving the gesture. For example, when the pinch gesture moves the zoom level below a predetermined zoom threshold (e.g. 50%, 55%, 60% . . . ) the overview mode may be entered. According to an embodiment, the entry of the overview mode is configurable by an authorized user (e.g. enter using pinch gesture when zoom level of document is below 55%). Similarly, view manager 26 may exit the overview mode in response to different events (e.g. zoom level going above predetermined threshold, selecting a thumbnail, a heading in a drilled down view, a link in a displayed document map).

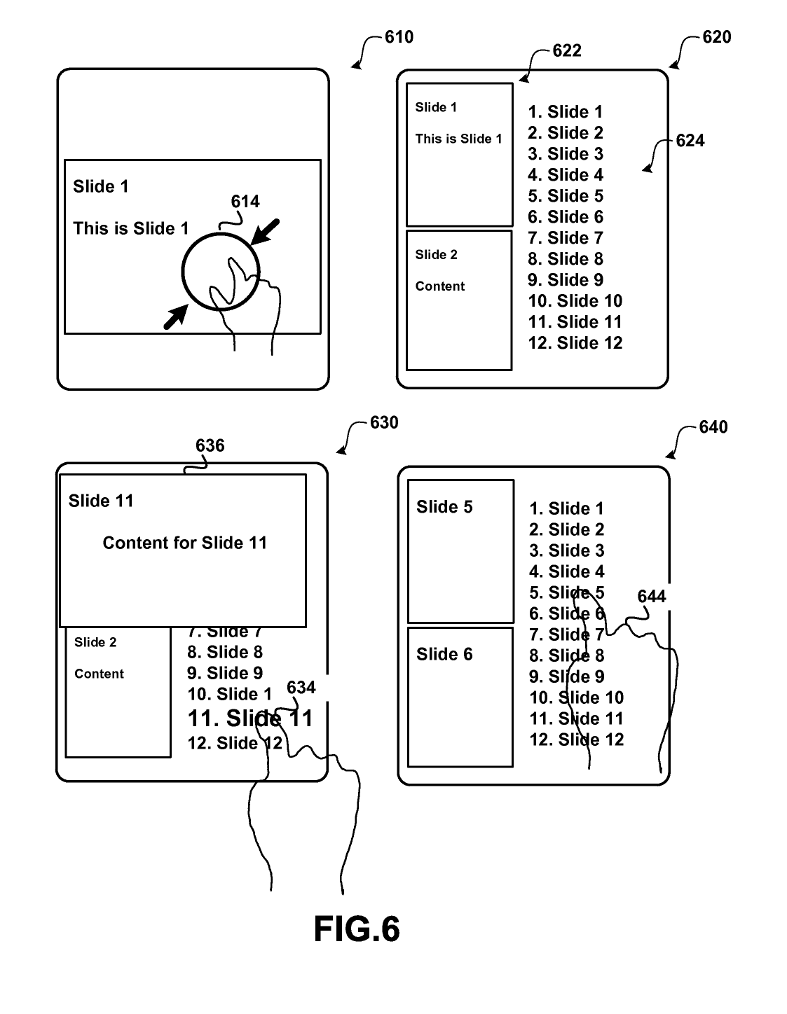

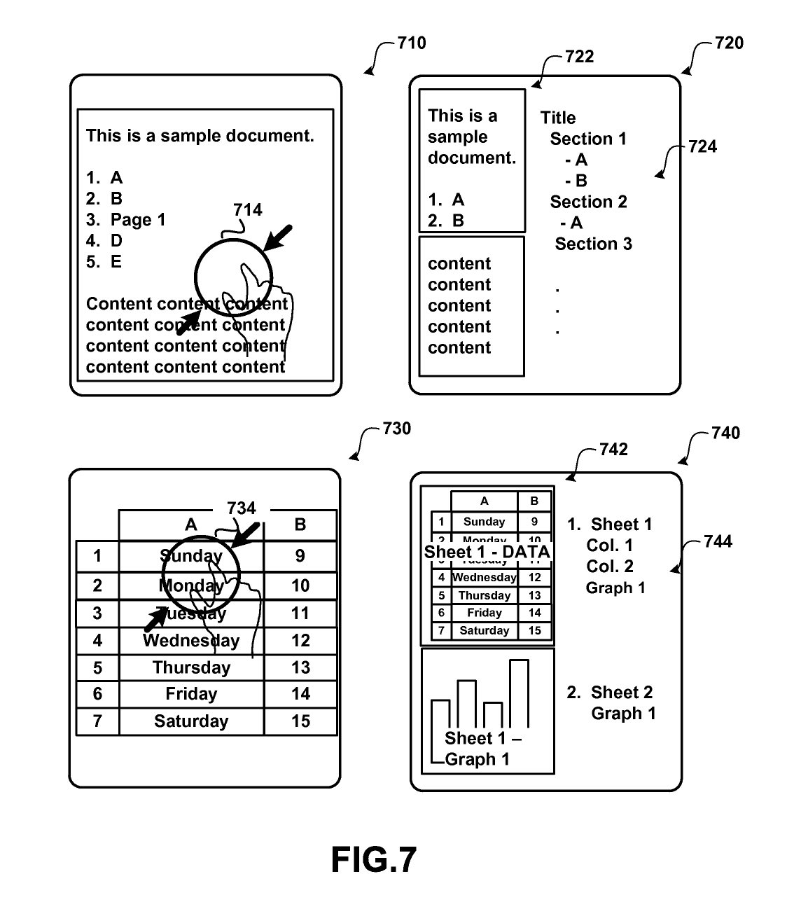

While in the overview mode, content is displayed as thumbnails such that a user may more easily locate content. In the current example, four thumbnails are initially displayed when the overview mode is entered in response to receiving the pinch gesture on Page 1. According to an embodiment, when the view is switched to the overview mode, the content displayed before moving to the overview mode is differentiated from the other content that is displayed in the thumbnails. In the current example, the thumbnail representing Page 1 is differentiated from the other thumbnails (e.g. highlighting, changing a border width or the thumbnail and/or providing some other indication). Differentiating the view of the previous content assists the user in determining what content was viewed before entering the overview mode. Other numbers of thumbnails may be initially displayed (e.g. 2, 4, 6, 8 . . . ). View manager 26 may change the number of thumbnails displayed while in the overview mode (e.g. receiving a pinch/stretch gesture). The thumbnails displayed may also be adjusted (e.g. up/down/left/right) using gestures (e.g. drag, swipe . . . ). A drill down view displays an expanded view of content (e.g. 164) for a thumbnail in response to receiving a drill down instruction (e.g. a tap and hold gesture 160 on a thumbnail). A thumbnail may also be selected (e.g. tapped) to return to the original viewing mode and to display the content of the selected thumbnail. A document map (See FIGS. 6 and 7) may also be instructed to be displayed by view manager 26 with a display of the thumbnails. The document map displays an outline of the content that includes selectable levels to assist in navigating the content. More details regarding the overview mode are provided below.

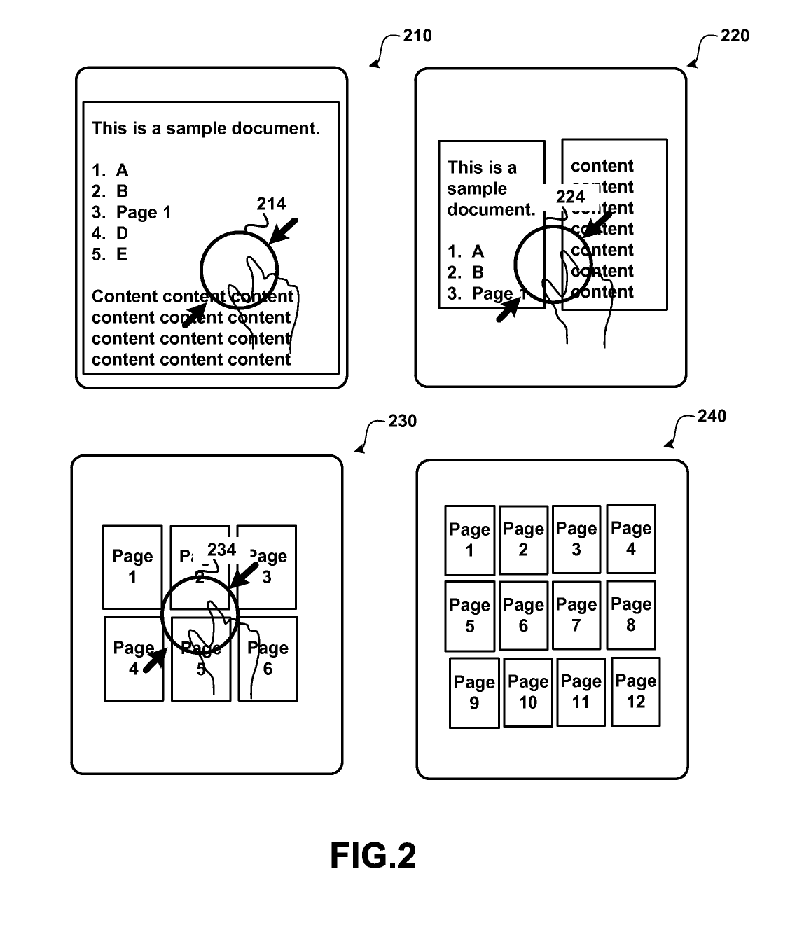

FIG. 2 shows entering an overview mode and changing a number of thumbnails displayed. As illustrated, FIG. 2 includes four different displays (210, 220, 230 and 240) that illustrate entering the overview mode and displaying thumbnails. The displays may be shown on displays having a standard/large display (e.g. displays larger than 12 inches) as well as a device having a limited display size (e.g. a cell phone having a display of approximately 2 by 3 inches, a slate/tablet having approximately a 7-10 inch display, and/or other devices having other display sizes (e.g. 4, 5, 6,). The displays may also be shown on a touch screen.

Display 210 shows a display of content before an overview mode is entered. The content may be a variety of content (e.g. a word-processing document, a presentation including slides, a workbook including one or more spreadsheets, web pages, and the like). In the current example, the user performs a pinch gesture 214 be pulling together their index finger and thumb to create a pinching action in order to enter the overview mode. As a result of the pinch gesture, the overview mode is entered and thumbnails are displayed that provide the user with more displayed content.

In the current example, two thumbnails are initially shown in the display as illustrated by display 220. More thumbnails may be initially displayed. According to an embodiment, each thumbnail represents a page of a document (e.g. page of word-processing document, slide from a presentation, sheet of a spreadsheet workbook, and the like). According to another embodiment, each thumbnail represents a portion of the content (e.g. 50%, 33%, 16% and the like). The content that is displayed in the thumbnail may be a zoomed out view of the content without changing the actual content, a zoomed out view of a modified view of the content, and/or a representation of the content. When there are larger thumbnails displayed, the content may actually be a zoomed out view of the content. As there are more thumbnails displayed in the view and the thumbnails are smaller, the level of detail in the thumbnail changes. For example, when a bar chart is converted into a thumbnail that occupies roughly half of a limited display device, the display is a zoomed out view without changing the content displayed in the thumbnail. As the size if the thumbnail goes down (e.g. 25% of the screen) a portion of the content may be removed (e.g. remove the Index and the Axis labels). When the size of the thumbnail goes down further, the actual content, which is a chart in this example, is replaced with a graphical icon replacing the content.

Display 230 shows more thumbnails being displayed in response to receiving another pinch gesture 224 as illustrated in display 220. In the current example, the number of thumbnails increased to six thumbnails. The number of thumbnails that are displayed may be changed using other increments (e.g. 2 to 4, 2 to 8, 2 to 3, and the like). According to an embodiment, the displayed thumbnails may be modified in response to receiving user input. For example, a user may select and move a thumbnail from one location to another within the overview mode using a drag and drop action (or some other input). Moving the thumbnail moves the location of the content within the document. A user may also delete a page (e.g. a delete gesture, a display of an option to delete the page in response to receiving a selection action) and/or hide a page (e.g. hide a notes page). A user may also insert a new page within a document. Other actions may also be performed. According to an embodiment, a context menu may be displayed in response to selection of a thumbnail that displays different options that can be performed on the thumbnail (e.g. delete, insert before/after, move, hide, cut, copy, paste . . . ).

Display 240 shows more thumbnails being displayed in response to receiving another pinch gesture 234 as illustrated in display 230. In the current example, the number of thumbnails increased to twelve thumbnails.

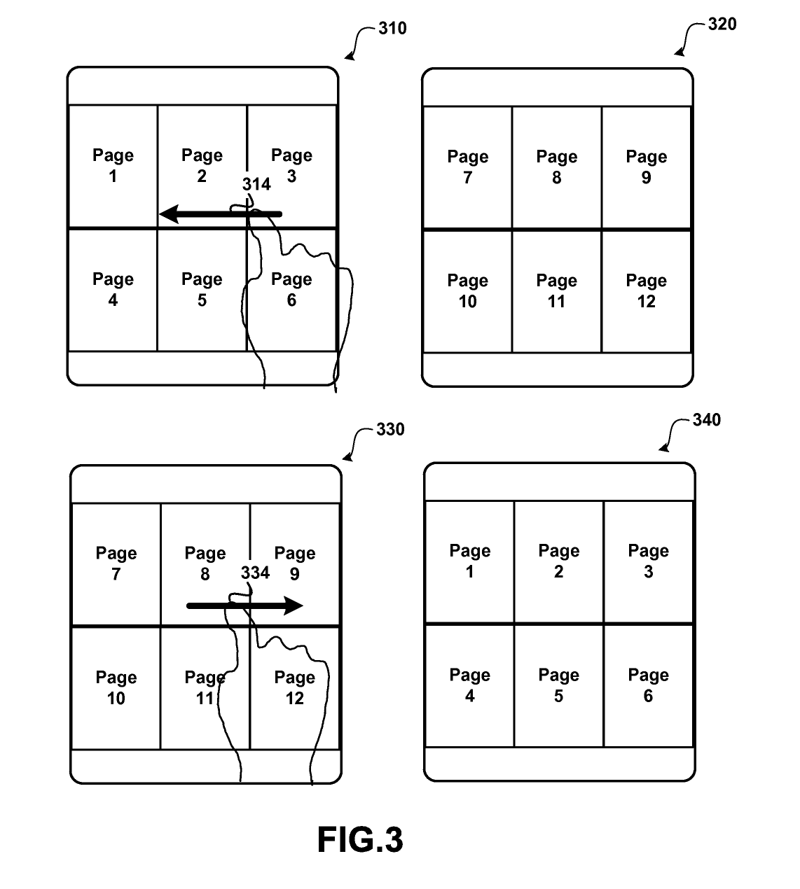

FIG. 3 illustrates changing a display of the thumbnails in the overview mode. As illustrated, FIG. 3 includes four different displays (310, 320, 330 and 340).

Display 310 shows a user performing a swipe gesture 314 to change the thumbnails displayed from the current six thumbnails shown (Page 1-Page 6).

Display 320 shows the thumbnails displayed in response to receiving the swipe gesture. As can be seen, the next six available thumbnails for the content are displayed. In the current example, thumbnails for pages 7-12 are displayed.

Display 330 shows a user performing a swipe gesture 334 in the opposite direction from gesture 314 to change the thumbnails displayed from the current six thumbnails shown.

Display 340 shows the thumbnails displayed in response to receiving the swipe gesture. As can be seen, the previous six available thumbnails for the content are displayed. In the current example, thumbnails for pages 1-6 are displayed.

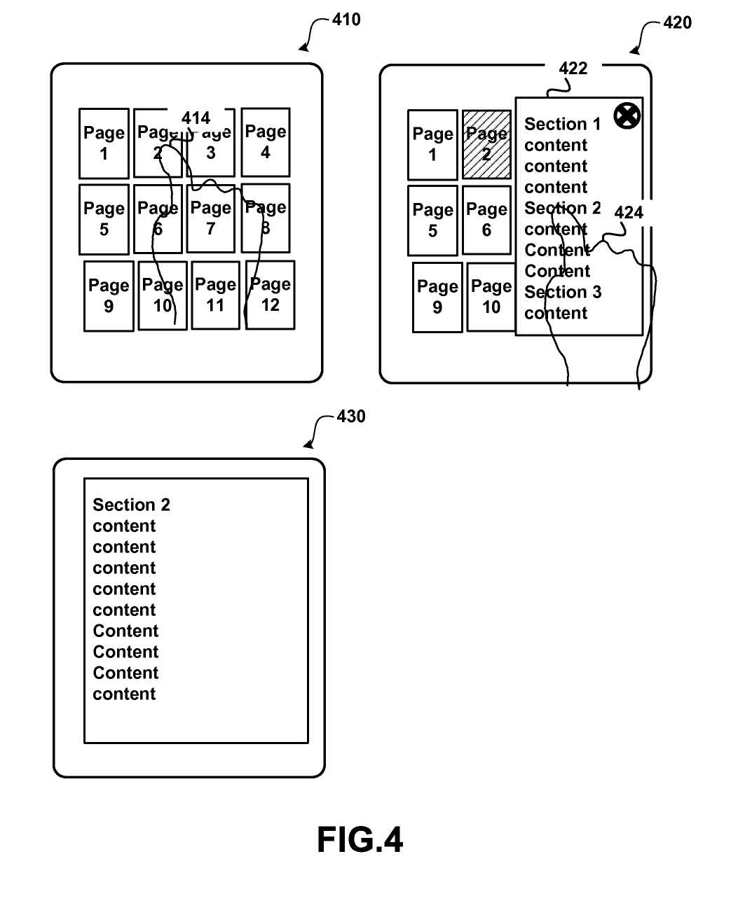

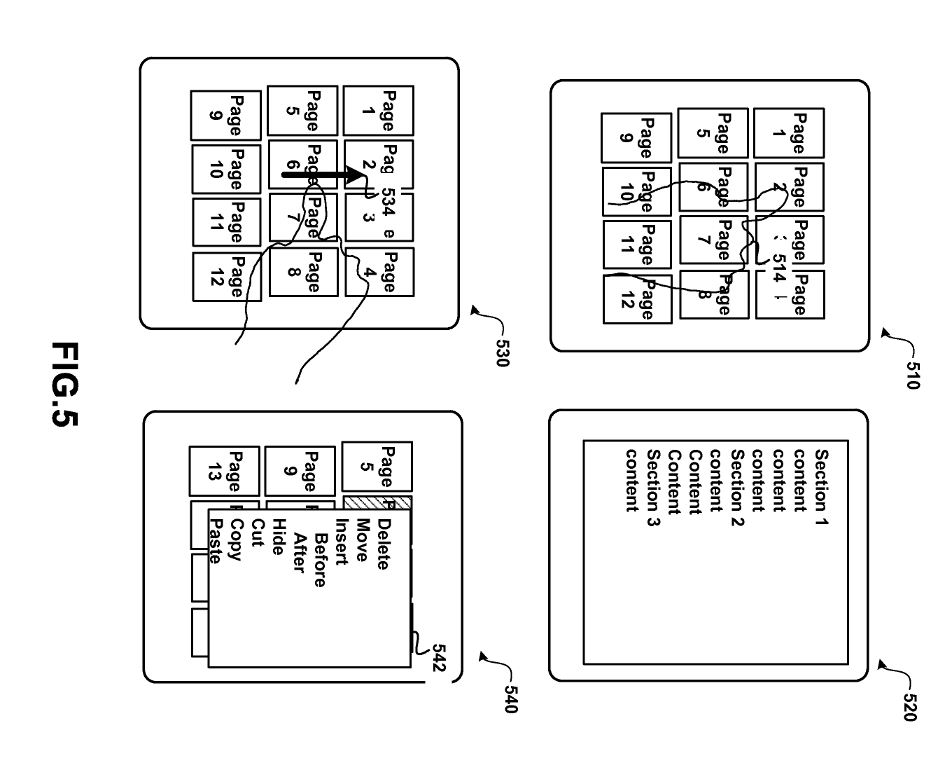

FIG. 4 shows displaying a drill down view for a thumbnail while in overview mode and showing a single page view in response to selecting a thumbnail. As illustrated, FIG. 4 includes three different displays (410, 420 and 430).

Display 410 shows a display of thumbnails (Page 1-12) while in overview mode. In the current example, a user taps and holds on the page 2 thumbnail to initiate a display of a drill down view for the thumbnail being pressed.

Display 420 shows a drilled down view 422 of thumbnail (Page 2) in response to receiving tap and hold gesture 414. As can be seen in display 420, drill down view 422 shows an expanded view of content that is associated with the page 2 thumbnail. In the current example, the thumbnail for page 2 is highlighted to indicate the tap and hold selection. Instead of having to exit the overview mode, the user may simply use the drill down gesture (e.g. tap and hold) to temporarily view more content associated with the thumbnail. A user may exit the drill down view by tapping in some other location of display 420. According to an embodiment, the user may also tap on a portion of the content within the drill down view to exit the drill down view and display a full page view of content near the tap. In the current example, a user has tapped on “Section 2” in the drill down view that results in a display of content as shown in display 430.

FIG. 5 illustrates changing a display of the thumbnails. As illustrated, FIG. 5 includes four different displays (510, 520, 530 and 540).

Display 510 shows twelve thumbnails (Page 1-12) while in an overview mode. As illustrated a user is selecting a thumbnail (Page 2) by performing a tap gesture 514.

Display 520 shows content for Page 2 in response to the selection of the page 2 thumbnail. According to an embodiment, when a “tap” gesture is received, the overview mode is exited and replaced with the display of content from the selected thumbnail. Other actions may be performed in response to receiving a “tap” gesture. For example, a single “tap” highlights the thumbnail and another “tap” on the highlighted thumbnail exits the overview mode and the display is replaced with the display of content from the selected thumbnail.

Display 530 shows a user performing a swipe gesture 534 in an upwards direction to change the thumbnails displayed from the current twelve thumbnails shown (Page 1-12).

Display 540 shows the thumbnails displayed in response to receiving the swipe gesture and displaying a menu in response to a selection of a thumbnail. As can be seen, the twelve available thumbnails displayed are changed to Pages 5-16 instead of Pages 1-12. While not shown, a down gesture may be used to change the display of the thumbnails (e.g. Pages 5-16 to Pages 1-12). According to an embodiment, a menu 542 is displayed in response to the single tap that provides various options that may be performed (e.g. delete, insert before/after, move, hide, cut, copy, paste . . . ).

FIG. 6 illustrates changing a display of the thumbnails. As illustrated, FIG. 6 includes four different displays (610, 620, 630 and 640).

Display 610 shows a view of a slide in a presentation before an overview mode is entered. As illustrated, a user is performing a pinch gesture 614 to move into an overview mode.

Display 620 shows a display of content for the presentation that is displayed in response to entering the overview mode. In the current example, thumbnails 622 for two slides are shown (Slide 1 and Slide 2) along with a document map 624. The document map displays an outline of the content that includes selectable options to assist in navigating the content. In the current slide presentation example, document map 624 shows a listing of slides within the presentation. While only two thumbnails are illustrated in the current example, more thumbnails may be shown. The sizing of the thumbnails may also be changed. For example, the thumbnails that are displayed may be the same size or they may include different sized thumbnails (e.g. first thumbnail takes 50% of available thumbnail space and the second and third thumbnail use the other 50% of the available thumbnail space. As another example, content that is close to the current selection may be illustrated using larger sized thumbnails whereas thumbnails farther away may be displayed using smaller sized thumbnails. As yet another example, the selected thumbnail may be displayed brighter than the other thumbnails (e.g. the other thumbnails appear slightly dimmed, but still clearly visible, from the selected thumbnail).

A user may also navigate the thumbnails as described above. For example, a user may use a swipe gesture to change the thumbnails displayed and update the document map when needed. For example, a display of the document map may be adjusted to include portions of the document map that were not previously visible when the document map for the entire content does not fit within the document map display area. A user may perform a “tap and hold” gesture to display a drill down view on a thumbnail and/or on selectable content that is displayed on the document map.

Display 630 shows a user performing a tap and hold gesture 634 on Slide 11 shown in the document map. In response to receiving the tap and hold gesture, a drill down view 636 is shown for Slide 11.

Display 640 shows a user performing a tap gesture 644 on Slide 5 in the document map. According to an embodiment, tapping on a selectable element in the document map changes the display of the thumbnails to include a display of thumbnails near the selection in the document map. According to another embodiment, a tap selection may exit the overview mode and display the selected content.

FIG. 7 illustrates entering an overview mode with a display of a document map. As illustrated, FIG. 7 includes four different displays (710, 720, 730 and 740).

Display 710 shows a view of a document before entering an overview mode with a display of a document map. As illustrated, a user is performing a pinch gesture 714 to move into an overview mode.

Display 720 shows a display of thumbnails 722 with a display of a document map 724 for the document. In the current example, thumbnails for two pages of the document are shown. In the current document example, document map 724 shows a listing of different portions of the document.

Display 730 shows a view of a spreadsheet before entering an overview mode with a display of a document map. As illustrated, a user is performing a pinch gesture 734 to move into an overview mode.

Display 740 shows a display of thumbnails 742 with a display of a document map 744 for the spreadsheet and/or workbook. In the current example, thumbnails for different content from the same spreadsheet are shown. The thumbnails may also show different available sheets in a workbook. In the current spreadsheet example, document map 744 shows a listing of different portions of the spreadsheet including different sheets of a workbook.

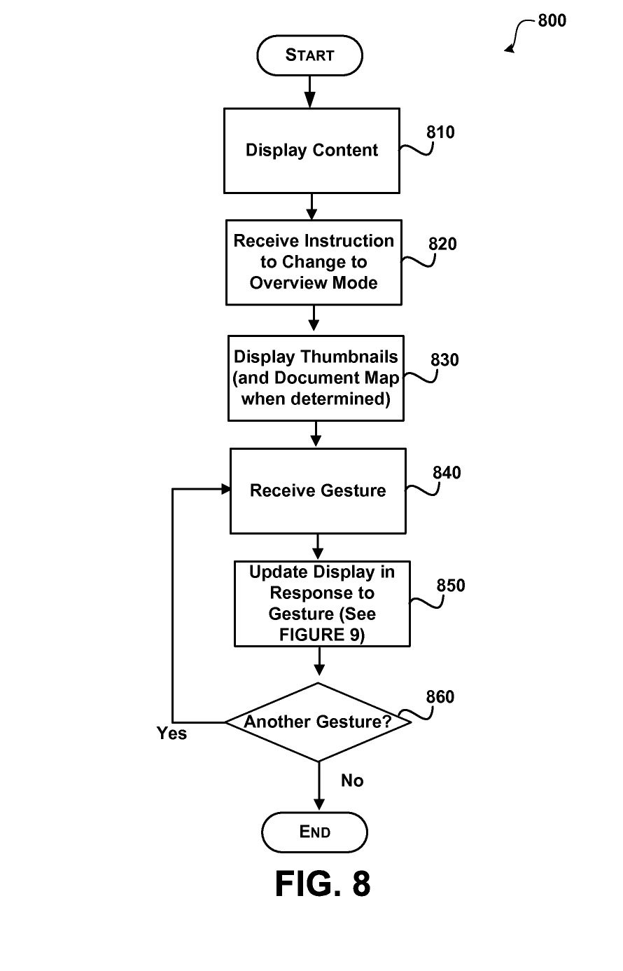

FIG. 8 shows an illustrative processes 800 for entering an overview mode and navigating content using the overview mode. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 810, where content is displayed. The content displayed may be different types of contents. For example, the content may be a spreadsheet, a document, a presentation, images, files, and the like.

Flowing to operation 820, an instruction to change to an overview mode is received. According to an embodiment, a touch input gesture is received to enter the overview mode from a viewing mode that does not include a view of multiple pages. For example, a user performs a pinch gesture to enter the overview mode. As discussed, the overview mode by entered immediately upon receiving a gesture that is associated with entering the overview mode or may be entered using information in addition to receiving the gesture. For example, when the pinch gesture moves below a predetermined zoom threshold (e.g. 50%, 55%, 60% . . . ) the overview mode may be entered. According to an embodiment, the entry of the overview mode is configurable by an authorized user (e.g. enter using pinch gesture when zoom level of document is below 55%). Similarly, view manager 26 may exit the overview mode in response to different events (e.g. zoom level going above predetermined threshold, selecting a thumbnail, a heading in a drilled down view, a link in a displayed document map).

Moving to operation 830, thumbnails are displayed in response to entering the overview mode. While in the overview mode, the content is displayed as thumbnails such that a user may more easily locate content. For example, four thumbnails may be initially displayed or some other number of thumbnails may be initially displayed (e.g. 2, 4, 6, 8 . . . ). According to an embodiment, a document map may be shown in response to entering the overview mode. The showing of the document map may be pre-configured and/or a selection may be made to show the document map. The document map displays an outline of the content that includes selectable levels to assist in navigating the content.

Moving to operation 840, a gesture is received while in the overview mode. A gesture may be received to navigate to different thumbnails, drill down into a thumbnails, and select a thumbnail.

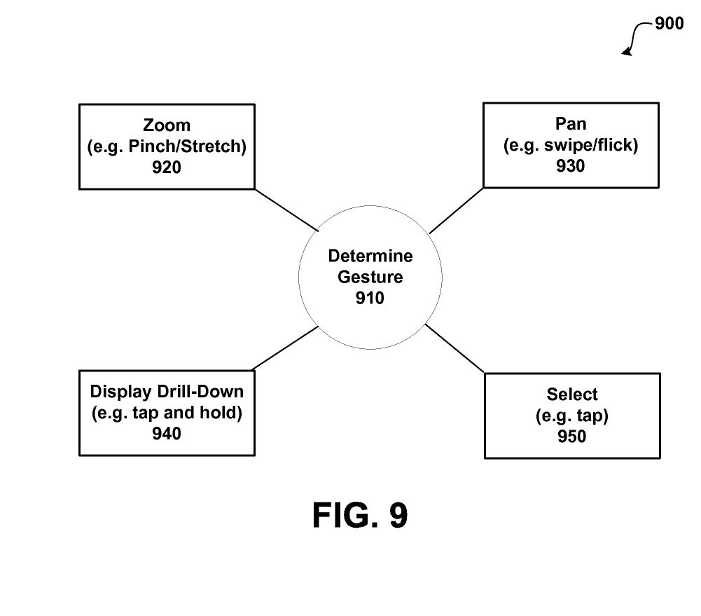

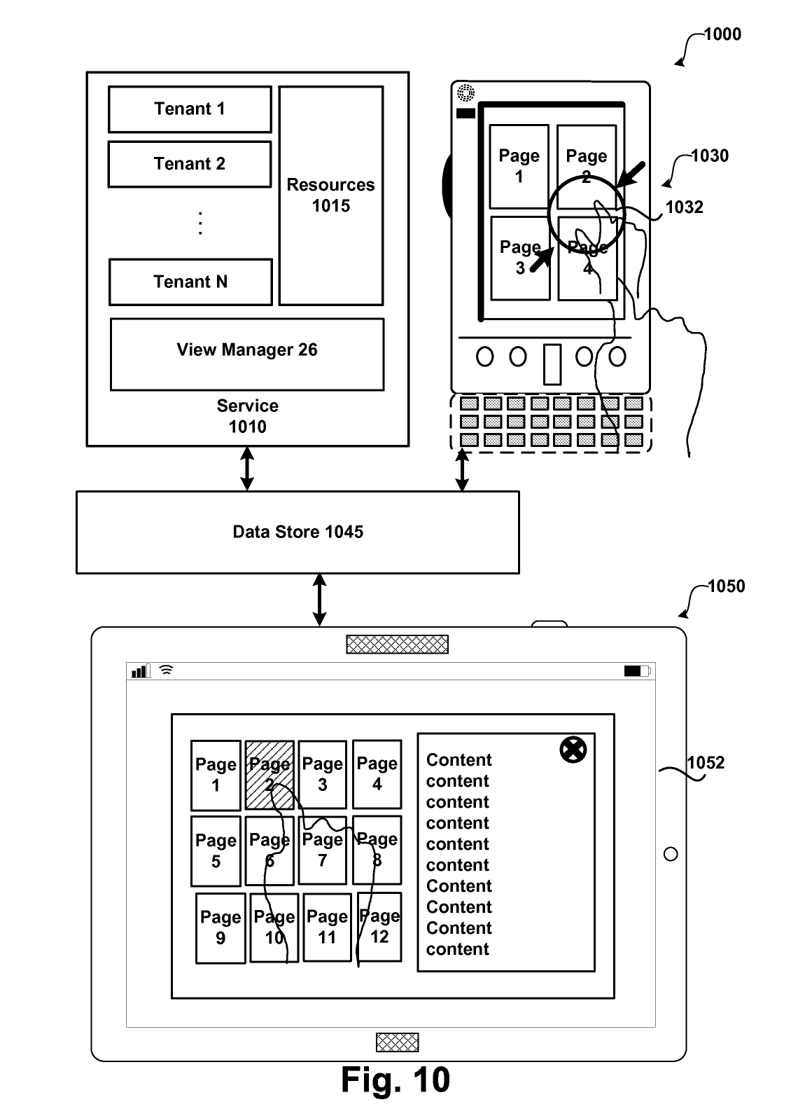

Flowing to operation 850, the display is updated in response to receiving the gesture. For example, the number of thumbnails displayed may change, the thumbnails that are displayed may change, a drill down view of content may be changed, the overview mode may be exited, and the like (See FIG. 9 for more details).

Transitioning to decision operation 860, a determination is made as to whether another gesture has been received. When there is another gesture, the process returns to operation 840. When there is not another gesture, the process then flows to an end operation and returns to processing other actions.

FIG. 9 shows a diagram illustrating processing different gestures while in an overview mode.

Operation 910 determines what gesture is received. According to an embodiment, the gesture may relate to zooming, panning, drilling down, and selecting. For example, a zooming gesture may be a pinch/stretch gesture. A panning gesture may be a swipe/flick gesture. A drill-down gesture may be a tap and hold gesture and a select gesture may be a tap gesture. Other gestures may be associated with the actions and/or other actions (e.g. delete, insert, hide . . . ).

When the gesture is a zoom gesture 920 where the number of thumbnails displayed changes and the overview mode is possibly exited. For example, a pinch gesture increases the number of thumbnails displayed while a stretch gesture reduces the number of thumbnails displayed. As discussed herein, the overview mode may be entered/exited when the zoom level reaches a certain level.

When the gesture is pan gesture 930, the display of the thumbnails is adjusted to show an updated set. According to an embodiment, the pan gesture may move the thumbnails in an upward direction, a downward direction, a sideways direction and a diagonal direction.

When the gesture is a drill-down gesture 940, an expanded view of the content associated with the selected element (thumbnail or element in document map) is shown.

When the gesture is a select gesture 950, the overview mode may exit and the selected content shown.

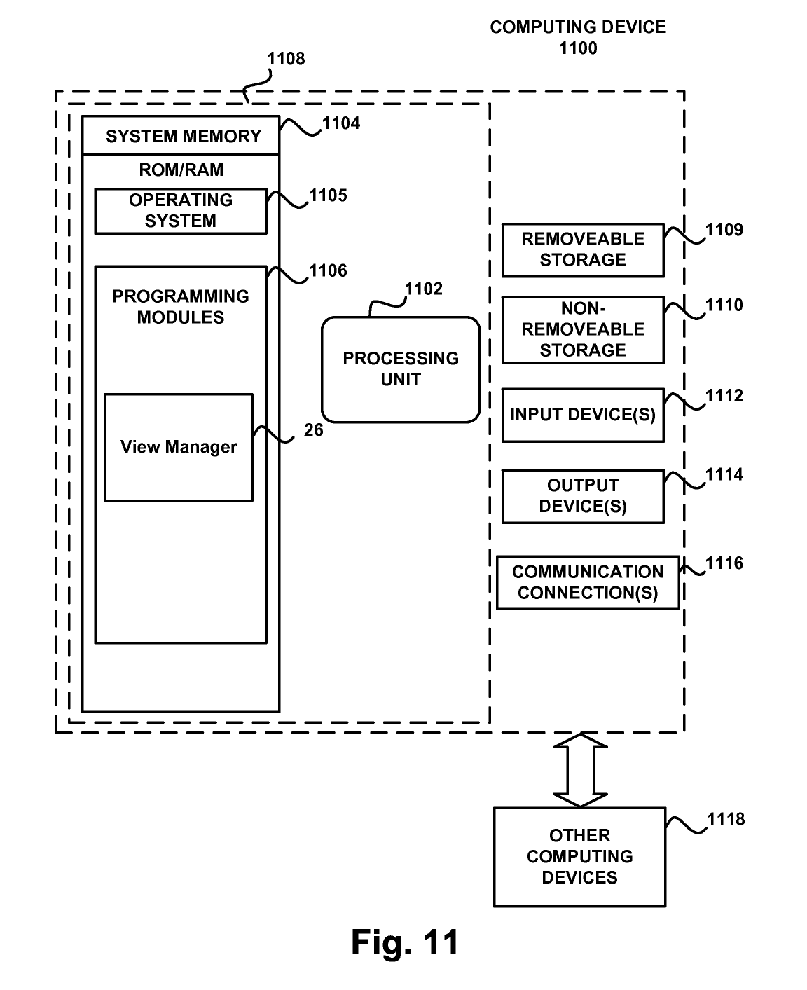

FIG. 10 illustrates an exemplary system for using an overview mode to navigate content. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as productivity services (e.g. MICROSOFT OFFICE 365 or some other cloud based/online service that is used to interact with content and documents (e.g. spreadsheets, documents, presentations, charts, messages, and the like). The service may be interacted with using different types of input/output. For example, a user may use touch input, hardware based input, speech input, and the like. The service may provide speech output that combines pre-recorded speech and synthesized speech. Functionality of one or more of the services/applications provided by service 1010 may also be configured as a client/server based application. Although system 1000 shows a service relating to productivity applications, other services/applications may be configured.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with different applications.

As illustrated, touch screen input device/display 1050 and smart phone 1030 shows exemplary displays 1052/1032 showing the use of an application using an overview mode to navigate content. Data may be stored on a device (e.g. smart phone 1030, slate 1050 and/or at some other location (e.g. network data store 1045). The applications used by the devices may be client based applications, server based applications, cloud based applications and/or some combination.

View manager 26 is configured to perform operations relating to using an overview mode to navigate content. While manager 26 is shown within service 1010, the functionality of the manager may be included in other locations (e.g. on smart phone 1030 and/or slate device 1050).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 11-13 and the associated descriptions provide a discussion of a variety of operating environments in which embodiments of the invention may be practiced. However, the devices and systems illustrated and discussed with respect to FIGS. 11-13 are for purposes of example and illustration and are not limiting of a vast number of computing device configurations that may be utilized for practicing embodiments of the invention, described herein.

FIG. 11 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a view manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to method 900 as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

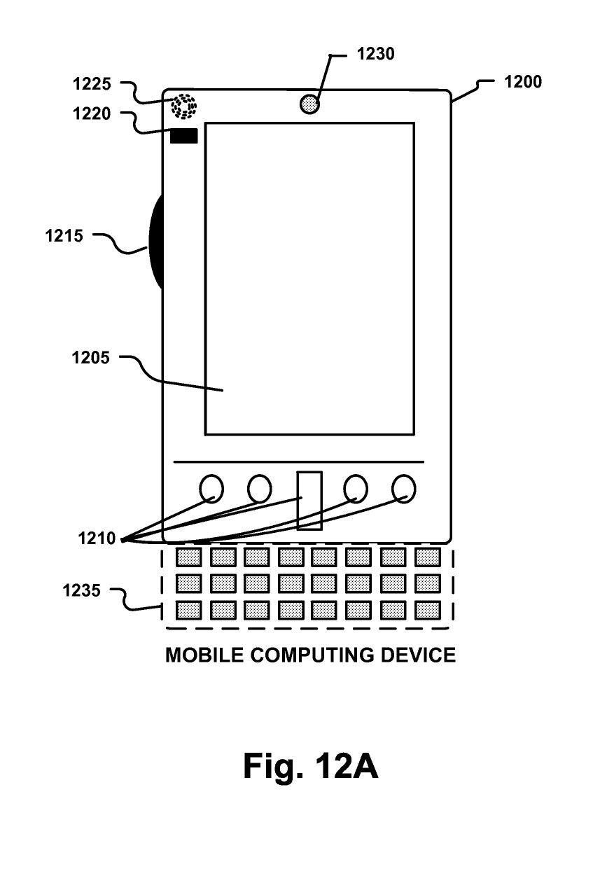

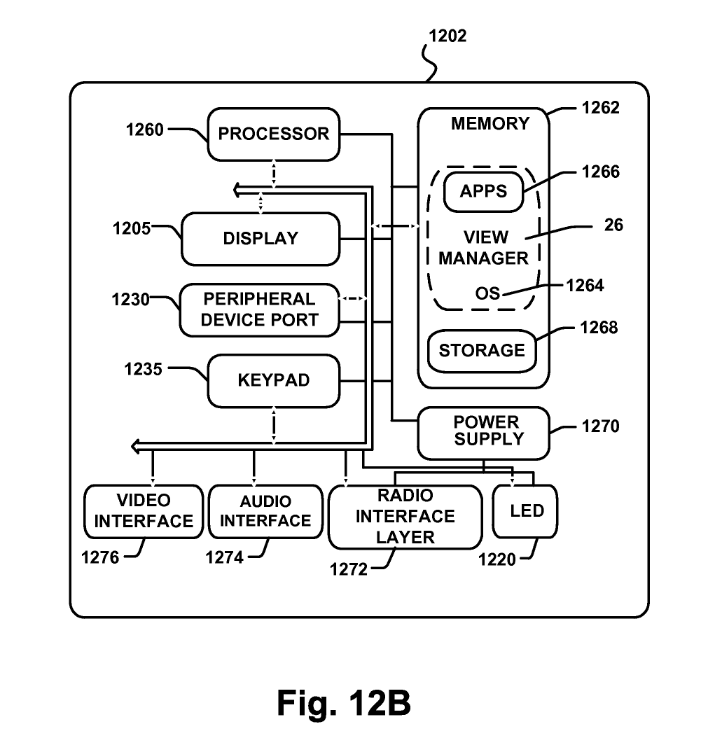

FIGS. 12A and 12B illustrate a suitable mobile computing environment, for example, a mobile telephone, a smartphone, a tablet personal computer, a laptop computer, and the like, with which embodiments of the invention may be practiced. With reference to FIG. 12A, an example mobile computing device 1200 for implementing the embodiments is illustrated. In a basic configuration, mobile computing device 1200 is a handheld computer having both input elements and output elements. Input elements may include touch screen display 1205 and input buttons 1215 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1215. Mobile computing device 1200 may also include an optional keypad 1235. Optional keypad 1215 may be a physical keypad or a “soft” keypad generated on the touch screen display.

Mobile computing device 1200 incorporates output elements, such as display 1205, which can display a graphical user interface (GUI). Other output elements include speaker 1225 and LED light 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 12B is a block diagram illustrating components of a mobile computing device used in one embodiment, such as the computing device shown in FIG. 12A. That is, mobile computing device 1200 can incorporate system 1202 to implement some embodiments. For example, system 1202 can be used in implementing a “smart phone” that can run one or more applications similar to those of a desktop or notebook computer such as, for example, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 1262 and run on or in association with operating system 1264. Examples of application programs include phoneme dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the view manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone 1220 to receive audible input, such as to facilitate a telephone conversation. In accordance with embodiments of the present invention, the microphone 1220 may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 12B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

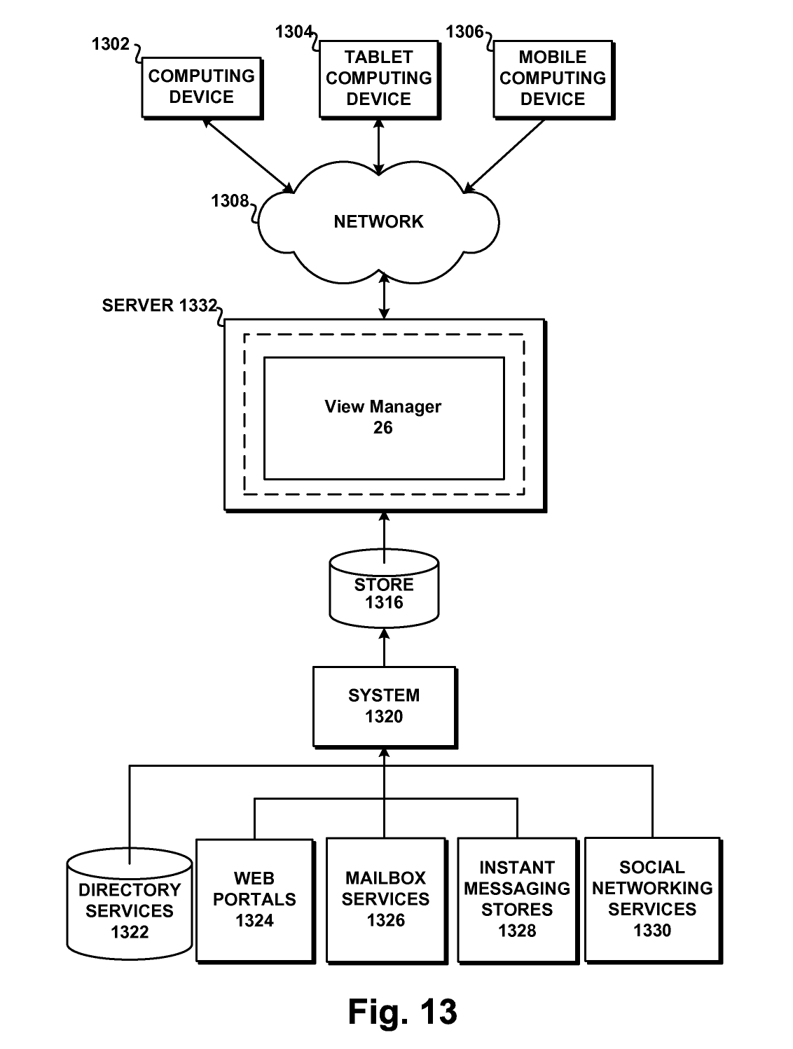

FIG. 13 illustrates a system architecture for using an overview mode to navigate content.

Components managed via the view manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to creating an application using shared code across different platforms. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended

What is claimed is:

1. A method for navigating a document, comprising:
displaying a view of content;
receiving an overview instruction to change the view of the content to an overview mode;
changing the view of the content to display thumbnails of at least a portion of the content; and
while in the overview mode, determining when to perform at least one of: displaying additional content in addition to the thumbnails in response to a received interaction with one of the thumbnails and changing a number of thumbnails displayed in response a received gesture while in the overview mode.

2. The method of claim 1, further comprising displaying a document map near a display of the thumbnail view while in the overview mode.

3. The method of claim 1, wherein receiving the overview instruction comprises receiving a pinch gesture and while in the overview mode changing the number of thumbnails that are displayed and a level of detail displayed in response to the received gesture that is one of: a pinch gesture and a stretch gesture, wherein as the level of detail changes the content displayed within each of the thumbnails changes between different views comprising: a zoomed out view of the content; a zoomed out view of the content modified and a representation of the content.

4. The method of claim 1, wherein displaying additional content in addition to the thumbnails in response to the received interaction with one of the thumbnails comprises displaying a drill down view of at least a portion of one of the thumbnails.

5. The method of claim 4, wherein the received interaction with the one of the thumbnails comprises receiving a tap and hold gesture.

6. The method of claim 1, further comprising adjusting a view of the displayed thumbnails in response to receiving a pan gesture and when the pan gesture is received changing the thumbnails that are displayed.

7. The method of claim 1, further comprising receiving a selection of one of the thumbnails and in response to receiving the selection exiting the overview mode and display content that is associated with the selected thumbnail.

8. The method of claim 2, wherein displaying a document map near a display of the thumbnail view while in the overview mode comprises displaying selectable indicators representing different portions of the content that when selected updates the display of the thumbnails.

9. The method of claim 1, wherein the content is from one of a: word-processing document, a presentation comprising slides, and a spreadsheet.

10. A computer-readable medium storing computer-executable instructions for selecting content, comprising:
displaying a view of content;
receiving an overview touch gesture to change the view of the content to an overview mode;
changing the view of the content to display thumbnails of the content; and
while in the overview mode, determining when to perform at least one of: displaying additional content in addition to the thumbnails in response to a received interaction with one of the thumbnails and changing a number of thumbnails displayed in response a received gesture while in the overview mode.

11. The computer-readable medium of claim 10, further comprising displaying a document map near a display of the thumbnail view while in the overview mode.

12. The computer-readable medium of claim 11, wherein displaying a document map near a display of the thumbnail view while in the overview mode comprises displaying selectable indicators representing different portions of the content that when selected updates the display of the thumbnails.

13. The computer-readable medium of claim 10, wherein while in the overview mode increasing the number of thumbnails that are displayed in response to receiving a pinch gesture and decreasing the number of thumbnails that are displayed in response to receiving a stretch gesture and changing a level of detail between different views comprising: a zoomed out view of the content; a zoomed out view of the content modified and a representation of the content.

14. The computer-readable medium of claim 10, wherein displaying additional content in addition to the thumbnails in response to the received interaction with one of the thumbnails comprises displaying a drill down view of at least a portion of one of the thumbnails in response to receiving a tap and hold gesture.

15. The computer-readable medium of claim 10, further comprising adjusting a view of the displayed thumbnails in response to receiving a pan gesture and when the pan gesture is received changing the thumbnails that are displayed.

16. The computer-readable medium of claim 10, further comprising receiving a selection of one of the thumbnails and in response to receiving the selection exiting the overview mode and display content that is associated with the selected thumbnail.

17. A system for selecting content, comprising:
a display that is configured to receive touch input;
a processor and memory;
an operating environment executing using the processor;
a display showing content; and
a view manager that is configured to perform actions comprising:
displaying a view of content;
receiving an overview touch gesture to change the view of the content to an overview mode;
changing the view of the content to display thumbnails of pages of the content; and
while in the overview mode, determining when to perform at least one of: displaying additional content in addition to the thumbnails in response to a received interaction with one of the thumbnails and changing a number of thumbnails displayed in response a received gesture while in the overview mode.

18. The system of claim 17, further comprising displaying a document map near a display of the thumbnail view while in the overview mode.

19. The system of claim 18, wherein displaying a document map near a display of the thumbnail view while in the overview mode comprises displaying selectable indicators representing different portions of the content that when selected updates the display of the thumbnails.

20. The system of claim 17, wherein while in the overview mode increasing the number of thumbnails that are displayed in response to receiving a pinch gesture and decreasing the number of thumbnails that are displayed in response to receiving a stretch gesture and changing a level of detail between different views comprising: a zoomed out view of the content; a zoomed out view of the content modified and a representation of the content.
